(19) United States
(12) Patent Application Publication
(10) Pub. No.: US 2016/0063535 A1
(43) Pub. Date: Mar. 3, 2016

(54) ELECTRONIC DEVICE AND WARNING METHOD OF SCREENING APPLICATIONS EXECUTABLE

(71) Applicants: SHENZHEN FUTAIHONG PRECISION INDUSTRY CO., LTD., Shenzhen (CN); Chiun Mai Communication Systems, Inc., New Taipei (TW)

(72) Inventor: YA-HUA XU, Shenzhen (CN)

(21) Appl. No.: 14/697,010

(22) Filed: Apr. 27, 2015

(30) Foreign Application Priority Data
Sep. 1, 2014 (CN) 201410441187.9

(51) Int. Cl. G06Q 30/02; G06F 3/0481

(52) U.S. Cl. CPC G06Q 30/0241; G06F 3/04817

(57) ABSTRACT

In a warning method of screening applications executable executed by an electronic device, at least one executable file of an application is screened and compared with advertisement features in an advertisement feature library. The application is determined whether to include one or more advertisements. When the application includes one or more advertisements, a sign is marked on an icon of the application which is displayed on a display device of the electronic device. When receiving an instruction to execute the application which includes one or more advertisement, a warning massage is outputted to request for confirmation to execute the application.

### CROSS-REFERENCE TO RELATED APPLICATIONS

This application claims priority to Chinese Patent Application No. 201410441187.9 filed on Sep. 1, 2014, the contents of which are incorporated by reference herein.

### FIELD

The subject matter herein generally relates to application management technology, and particularly to an electronic device and a warning method of screening applications executable.

### BACKGROUND

A plurality of applications can be installed in an electronic device (e.g., a smart phone or a tablet computer). However, these applications may include advertisements, which are played when/before the applications are running The advertisements may influence executions of the applications, or have viruses which can cause damage to information stored in the electronic device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one example embodiment of an electronic device.

FIG. 2 is a flowchart of one example embodiment of a warning method of screening applications executable.

FIG. 3 is a diagrammatic view of one example embodiment of the display screen of the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The present disclosure, including the accompanying drawings, is illustrated by way of examples and not by way of limitation. It should be noted that references to “an” or “one” embodiment in this disclosure are not necessarily to the same embodiment, and such references mean “at least one”.

The term “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

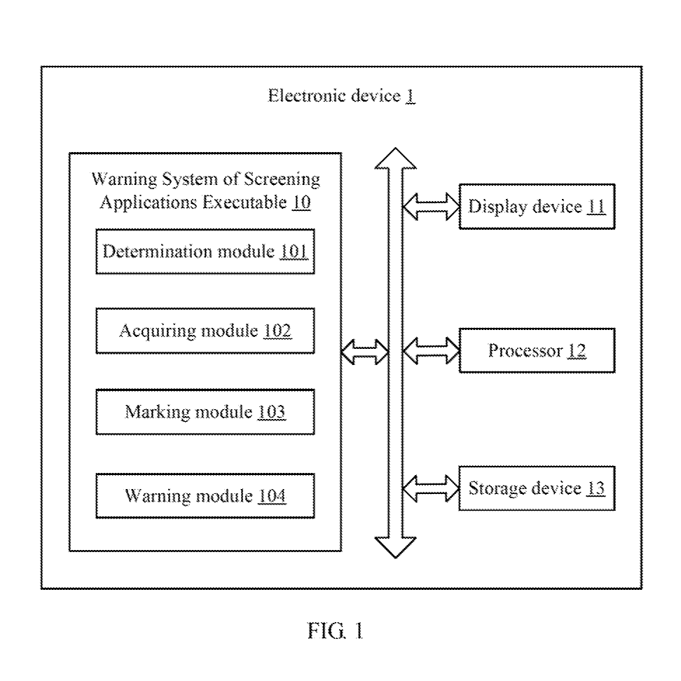

FIG. 1 is a block diagram of one example embodiment of an electronic device. In at least one embodiment as shown in FIG. 1, an electronic device 1 includes, but is not limited to a warning system of screening applications executable 10, a display device 11, at least one processor 12, and a storage device 13. The electronic device 1 can be a mobile phone, a tablet computer or any other mobile electronic device. FIG. 1 illustrates only one example of the electronic device that can include more or fewer components than illustrated, or have a different configuration of the various components in other embodiments.

In at least one embodiment, the at least one processor 12 can be a central processing unit (CPU), a microprocessor, or other data processor chip that performs functions of the electronic device 1. The storage device 13 can include various type(s) of non-transitory computer-readable storage medium. For example, the storage device 13 can be an internal storage system, such as a flash memory, a random access memory (RAM) for temporary storage of information, and/or a read-only memory (ROM) for permanent storage of information. The storage device 13 can also be an external storage system, such as a hard disk, a storage card, or a data storage medium.

When an application is installed or updated, the warning system of screening applications executable 10 can determine whether the application includes one or more advertisements. If the application includes one or more advertisements, the warning system of screening applications executable 10 marks a sign on an icon which is displayed on the display device 11. The warning system of screening applications executable 10 can also output a warning message to request for confirmation to execute the application when an instruction to execute the application is received.

In at least one embodiment, the warning system of screening applications executable 10 can include a determination module 101, an acquiring module 102, a marking module 103, and a warning module 104. The function modules 101-104 can include computerized codes in the form of one or more programs, which are stored in the storage device 13. The at least one processor 12 executes the computerized codes to provide functions of the function modules 101-104.

When an application is installed in the electronic device 1 or an application installed in the electronic device 1 is updated, the determination module 101 screens at least one executable file of the application, and compares the executable file with advertisement features in an advertisement feature library, and determines whether the application includes one or more advertisements.

In at least one embodiment, if an application includes one or more advertisements, the application should have special codes (e.g., one or more special classes) to implement the one or more advertisements. Each application installed in an operating system of the electronic device 1 has at least one executable file (e.g., DEX file). The executable file stores information of the application, such as a class list of the application. The determination module 101 acquires the information (e.g., the class list) stored in the executable file and compares the information with advertisement features in the advertisement feature library. When the information stored in the executable file includes one or more advertisement features (e.g., classes), the determination module 101 determines that the application includes one or more advertisements.

For example, an advertisement A can be implemented according to class B, class C and class D. The class B, class C and class D are features of the advertisement A. As mentioned above, the information stored in the executable file includes the class list of the application. If the class list includes class B, class C and class D, the determination module 101 determines that the application includes the advertisement A. If the class list merely includes class B and class C, the determination module 101 cannot determine that the application includes the advertisement A.

The advertisement feature library stores advertisement features, such as special classes which are used to implement advertisements. In at least one embodiment, the advertisement feature library can be stored in both of the storage device 13 of the electronic device 1 and a web server that is connected to the electronic device 1. The advertisement feature library stored in the storage device 13 can be updated periodically (e.g., at a specific time each day) according to updates of the advertisement feature library in the web server.

In other embodiments, the advertisement feature library can be merely stored in the web server. The electronic device 1 is connected to the web server. When the determination module 101 acquires the information stored in the executable file of the application, the determination module 101 sends the information to the web server. The web server compares the information received from the electronic device 1 with the advertisement features in the advertisement feature library, and returns a comparison result to the electronic device 1.

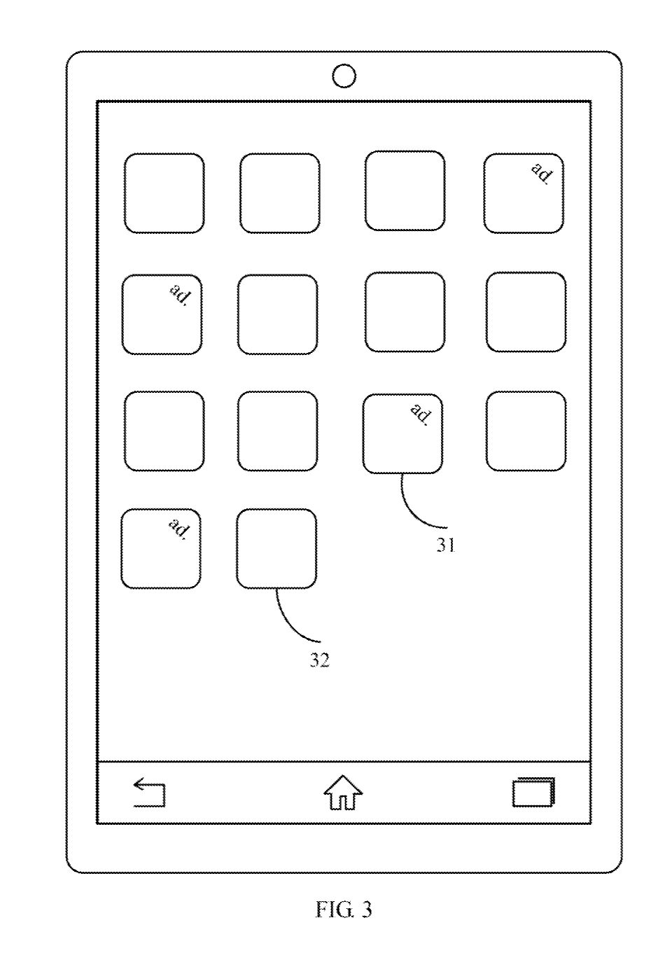

The marking module 103 marks a sign on an icon of the application which is displayed on the display device 11 when the application includes one or more advertisements. The sign can be letters, symbols, numerals, and/or icons. In at least one embodiment as shown in FIG. 3, the sign is letter. In FIG. 3, icon 31 having the sign is an icon of an application which includes one or more advertisements, and icon 32 is an icon of an application which does not include any advertisement.

When receiving an instruction to execute the application which includes one or more advertisements, the warning module 104 outputs a warning message to request for confirmation to execute the application. The warning massage also prompts that the application includes one or more advertisements. For example, when the marked icon of the application is been clicked, the warning module 104 determines that the instruction to execute the application is received. The warning module 104 outputs a warning message to request for confirmation to execute the application. The warning module 104 executes the application in response to receiving an agreed signal. When no agreed signal is received or a disagreed signal is received by the warning module 104, the application will not been executed.

In at least one embodiment, the warning module 104 creates a pop-up window and displays a warning message on the pop-up window, such as “The application includes one or more advertisements, do you still want to execute it?” The warning module 104 also displays two options in the window. The two options can include an option of “YES” and an option of “NO”. When the user selects the option of “YES”, the agreed signal can be received by the warning module 104. When the user selects the option of “NO”, the disagreed signal can be received by the warning module 104.

In some embodiments, the acquiring module 102 acquires properties of one or more advertisements which is included in the application. The properties of the one or more advertisements can be displayed on the warning message when the application is to be executed, such as “The application includes a pop-up advertisement, do you still want to execute it?” The “pop-up” is the property of the one or more advertisements.

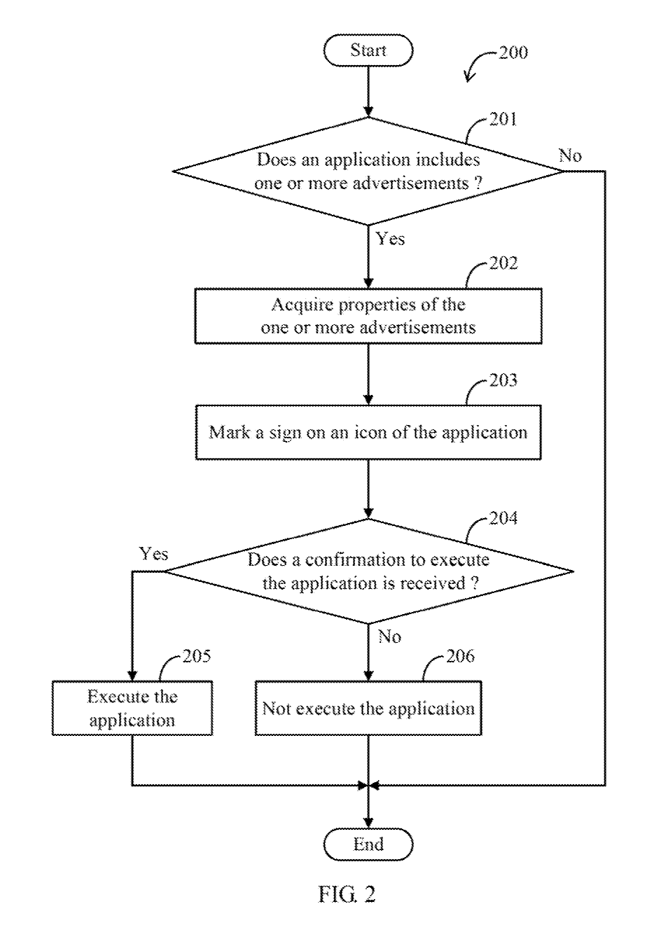

Referring to FIG. 2, a flowchart is presented in accordance with an example embodiment. The example method 200 is provided by way of example, as there are a variety of ways to carry out the method. The example method 200 described below can be carried out using the configurations illustrated in FIG. 1, for example, and various elements of these figures are referenced in explaining example method 200. Each block shown in FIG. 2 represents one or more processes, methods, or subroutines, carried out in the example method 200. Furthermore, the illustrated order of blocks is illustrative only and the order of the blocks can be changed. Additional blocks can be added or fewer blocks may be utilized without departing from this disclosure. The example method 200 can begin at block 201.

When an application is installed in the electronic device 1 or an application installed in the electronic device 1 is updated, at block 201, a determination module screens at least one executable file of the application, and compares the executable file with advertisement features in an advertisement feature library, and determines whether the application includes one or more advertisements. When the application includes one or more advertisements, block 202 is executed. When the application does not include any advertisement, the procedure ends.

The executable file stores information of the application, such as a class list of the application. The determination module acquires the information (e.g., the class list) stored in the executable file and compares the information with advertisement features in the advertisement feature library. When the information stored in the executable file includes one or more advertisement features (e.g., classes), the determination module determines that the application includes one or more advertisements.

The advertisement feature library stores advertisement features, such as special classes which are used to implement advertisements. In at least one embodiment, the advertisement feature library can be stored in both the storage device 13 of the electronic device 1 and a web server that is connected to the electronic device 1. The advertisement feature library stored in the storage device 13 can be updated periodically (e.g., at a specific time each day) according to updates of the advertisement feature library in the web server.

In other embodiments, the advertisement feature library can be merely stored in the web server. The electronic device 1 is connected to the web server. When the determination module acquires the information stored in the executable file of the application, the determination module sends the information to the web server. The web server compares the information received from the electronic device 1 with the advertisement features in the advertisement feature library, and returns a comparison result to the electronic device 1.

When an application includes one or more advertisements, at block 202, an acquiring module acquires properties of the one or more advertisements. In other embodiments, block 202 can be deleted or omitted.

At block 203, a marking module marks a sign on an icon of the application which is displayed on the display device 11 when the application includes one or more advertisements. The sign can be letters, symbols, numerals, and/or icons. In at least one embodiment as shown in FIG. 3, the sign is letters. In FIG. 3, icon 31 having the sign is an icon of an application which includes one or more advertisements, and icon 32 is an icon of an application which does not include advertisements.

When receiving an instruction to execute the application which includes one or more advertisements, at block 204, a warning module outputs a warning message to request for confirmation to execute the application. The warning massage also prompts that the application includes one or more advertisements. For example, when the marked icon of the application is been clicked, the warning module determines that the instruction to execute the application is received. The warning module outputs a warning message to request for confirmation to execute the application. The warning module executes the application in response to receiving an agreed signal. When no agreed signal is received or a disagreed signal is received by the warning module, the application will not been executed.

In at least one embodiment, the warning module creates a pop-up window and displays a warning message on the pop-up window, such as “The application includes one or more advertisements, do you still want to execute it?” In other embodiments, if the properties of the one or more advertisements is acquired, the properties can be also displayed on the warning massage, such as “The application includes a pop-up advertisement, do you still want to execute it?”

At block 205, the warning module executes the application, the procedure ends.

At block 206, the warning module does not execute the application, the procedure ends.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A warning method of screening applications executable being executed by at least one processor of an electronic device, the electronic device comprising a display device and at least one application, the method comprising:
screening at least one executable file of the application when the application is installed or updated, and comparing the executable file with advertisement features in an advertisement feature library, and determining whether the application comprises one or more advertisements;
if the application is determined to comprise one or more advertisement, marking a sign on an icon which is displayed on a display device of the electronic device to represent the application; and
outputting a warning message to request for confirmation to execute the application when receiving an instruction to execute the application which comprises one or more advertisements.

2. The method according to claim 1, wherein the advertisement feature library is updated periodically.

3. The method according to claim 1, wherein the sign is letters, symbols, numerals, or icons.

4. The method according to claim 1, wherein the executable file of the application is compared with the advertisement features in the advertisement feature library by:
acquiring classes information stored in the executable file, and comparing the classes information with the advertisement features in the advertisement feature library.

5. An electronic device comprising:
at least one processor, a display device; and
a storage device that stores one or more programs which, when executed by the at least one processor, causes the at least one processor to:
screen at least one executable file of an application when the application is installed or updated, and compare the executable file with advertisement features in an advertisement feature library, and determine whether the application comprises one or more advertisements;
if the application is determined to comprise one or more advertisement, mark a sign on an icon which is displayed on the display device of the electronic device to represent the application; and
output a warning message to request for confirmation to execute the application when receiving an instruction to execute the application which comprise one or more advertisements.

6. The electronic device according to claim 5, wherein the advertisement feature library is updated periodically.

7. The electronic device according to claim 5, wherein the sign is letters, symbols, numerals, or icons.

8. The electronic device according to claim 5, wherein the executable file of the application is compared with the advertisement features in the advertisement feature library by:
acquiring classes information stored in the executable file and comparing the classes information with the advertisement features in the advertisement feature library.

9. A non-transitory storage medium having shored thereon instruction that, when executed by at least one processor of an electronic device, causes the at least one processor to perform a warning method of screening applications executable, the method comprising:
screening at least one executable file of an application when the application is installed or updated, and comparing the executable file with advertisement features in an advertisement feature library, and determining whether the application comprises one or more advertisements;
if the application is determined to comprise one or more advertisement, marking a sign on an icon which is displayed on a display device of the electronic device to represent the application; and
outputting a warning message to request for confirmation to execute the application when receiving an instruction to execute the application which comprises one or more advertisements.

10. The non-transitory storage medium according to claim 9, wherein the advertisement feature library is updated periodically.

11. The non-transitory storage medium according to claim 9, wherein the sign is letters, symbols, numerals, or icons.

12. The non-transitory storage medium according to claim 9, wherein the executable file of the application is compared with the advertisement features in the advertisement feature library by:
acquiring classes information stored in the executable file and comparing the classes information with the advertisement features in the advertisement feature library.
